(19) United States
(12) Patent Application Publication
(10) Pub. No.: US 2005/0084064 A1
(43) Pub. Date: Apr. 21, 2005

(54) X-ray grading apparatus and process

(75) Inventor: Craig McIntyre, Coventry (GB)

Correspondence Address: LAHIVE & COCKFIELD, LLP., 28 STATE STREET, BOSTON, MA, 02109, US

(73) Assignee: Spectral Fusion Technologies Limited, Birmingham (GB)

(21) Appl. No.: 10/496,237

(22) PCT Filed: Nov. 19, 2002
(86) PCT No.: PCT/GB02/05185

(30) Foreign Application Priority Data
Nov. 20, 2001 (GB) 0127702.9

(51) Int. Cl. G01B 15/02; G01N 23/06

(52) U.S. Cl. 378/54

(57) ABSTRACT

The invention comprises an apparatus and process for determining the relative proportions by mass of two or more differing substances contained in a sample comprising a combination (e.g. a mixture) of the two or more differing substances. The apparatus comprises: (a) at least one X-ray radiation generator arranged to irradiate a said sample; (b) at least one X-ray radiation sensor comprising a plurality of pixels, each pixel having a predetermined area and being arranged to detect the intensity of X-ray radiation received by it, the sensor being arranged to receive X-ray radiation from the generator and to measure the X-ray radiation intensity detected by each pixel; and (c) data processing means; whereby, in use, a said sample is positioned between the X-ray radiation generator and the sensor and is irradiated by the generator, each pixel of the sensor detects the intensity of X-ray radiation received by it, the sensor measures the X-ray radiation intensity detected by each pixel, and the data processing means calculates the relative proportions by mass of the two or more differing substances contained in a said sample, using X-ray radiation intensity data measured by the sensor. The invention also comprises a process of dividing a plurality of samples, each of which comprises a combination of two or more differing substances, into two or more groups of the samples, the process comprising: determining the masses of each differing substance in each individual sample; and placing each sample into a respective group of the samples according to the masses of each differing substance in that sample such that each group has an overall mass ratio of the two or more differing substances which at least approximates to a predetermined target mass ratio for that group.

In the production of processed meat products, it is generally important to know or measure the fat to lean meat ratio. The amount of fat by percentage mass in processed meat products is controlled by legislation and is increasingly being noticed by health conscious consumers. Currently in the production of mincemeat for example, human meat graders estimate the percentage fat in each piece of flesh, and these pieces are then accumulated together to form a final mince product of a known and allowed percentage fat. The estimation of the ratio of fat/lean meat from visual appearance is not a precise measurement and therefore meat producers typical add slightly more lean meat to ensure that the fat content of the batch is below the labelled percentage value.

There have been several attempts to automate this process. One such attempt has been to use camera based inspection systems to measure the fat/lean meat ratio prior to grinding based on a different response of fat and lean meat to a white light illumination source, as disclosed in U.S. Pat. No. 5,668,634. Such systems have generally not been reliable because they only measure the surface fat content of a piece of meat and often the fat also lies within the body of the meat, and thus the percentage of fat is greatly underestimated. Attempts have been made to estimate the percentage of body fat based on measuring the surface fat percentage, but the correlation between surface fat and body fat has generally been found not to be accurate enough.

The use of X-ray technology to measure the relative amounts of two substances within a sample, such as fat content of meat is known, for example, from U.S. Pat. No. 2,992,332 (Madigan). This dealt with the measurement of the meat and fat content by measuring gamma ray penetration. U.S. Pat. No. 4,168,431 (Henriksen) disclosed that the Madigan system is limited by the necessity for carefully preparing samples to uniform pre-determined weight, size and geometrical configuration. Henriksen's system utilised three or more X-ray energy levels to overcome the variability of the samples under investigation. This system used an X-ray source whose excitation potential could be varied and a detector, which when used with a suitable filter, was capable of detecting the X-ray energy in use. The design of the system is generally suitable only for off-line processing of samples from a production batch, where the sample is first inspected at one X-ray energy level, and subsequently at different energy levels. From the meat processor's point of view, a system that can inspect their products on the production line, and without the requirement to prepare samples into uniform size and weight, and grade them would be much more beneficial.

The first X-ray systems generally relied on pumping the minced/ground meat through a pipeline. The thickness of meat in the pipeline is known and therefore it is a simple calculation to estimate the percentage of fat in a given volume through the pipeline because of the difference in X-ray transmission between the flesh and the fat. The problem with such pipeline inspection systems is that they measure the percentage of fat in the final/processed product. At this stage, the measurement of fat percentage is a useful quality assurance tool but it is too late to make any adjustment of the process. What is required is a system that can make a measurement of the fat/lean content on pieces of meat prior to the mincing/grinding stage.

U.S. Pat. No. 4,171,164 discloses a system whereby two separate streams of meat, one with high fat content and one with low fat content, are fed into a blending/grading stage. Each of the streams is continuously monitored by a polychromatic X-ray beam detected at a single energy level, to measure fat content within the stream. The flow rate of each stream is adjusted, dependent on the fat measurement, to obtain a target fat content of the mixed product. This system involves the use of two separate streams of product that have already had some form of processing to separate out the two different fat content meat streams.

U.S. Pat. No. 5,585,603 discloses a method and system for weighing an object, for example a meat food product, as it is carried on a conveyor past a single X-ray source, in which X-rays from the source pass through the object, are attenuated in proportion to the mass of the object through which they pass, and impinge upon an X-ray detector array. The X-ray detector array includes a layer of scintillating material that produces light in response to the intensity of the X-rays, and a plurality of photodiodes to detect the light. The intensity of the X-rays received at the X-ray detector array is indicated by signals produced by the photodiodes, which are periodically scanned by a processor. The photodiode signals are each converted to a value representing the average areal density for a volume element extending above the photodiode into the object. Using the average areal density for each volume element and the size of each volume element, the processor determines the mass of the volume element. The entire object is advanced, and the mass of the volume elements in the object are generated and stored. The total mass of an object is determined by summing the masses of the volume elements, and a mass map of an object is generated that represents the location and mass of all of the volume elements in the object. If the object is a food product, this information may be used to cut the product into pieces of different weights, or to indicate when defects exist within the product. The patent does not, however, disclose the determination of the relative proportions by mass of two or more differing substances contained in a product comprising a combination of the two or more differing products, and indeed the method and system disclosed in the patent would be incapable of such a determination.

According to a first aspect, the present invention provides an apparatus for determining the relative proportions by mass of two or more differing substances contained in a sample comprising a combination (e.g. a mixture) of the two or more differing substances, the apparatus comprising:
(a) at least one X-ray radiation generator arranged to irradiate a said sample;
(b) at least one X-ray radiation comprising a plurality of pixels, each pixel having a predetermined area and being arranged to detect the intensity of X-ray radiation received by it, the sensor being arranged to receive X-ray radiation from the generator and to measure the X-ray radiation intensity detected by each pixel; and
(c) data processing means;
   whereby, in use, a said sample is positioned between the X-ray radiation generator and the sensor and is irradiated by the generator, each pixel of the sensor detects the intensity of X-ray radiation received by it, the sensor measures the X-ray radiation intensity detected by each pixel, and the data processing means calculates the relative proportions by mass of the two or more differing substances contained in a said sample, using X-ray radiation intensity data measured by the sensor.

The present invention will be described primarily in terms of samples comprising a combination of meat (i.e. muscle) and fat. However, it is to be understood that the invention is applicable generally to samples comprising combinations of two or more differing substances, and its use in relation to meat and fat samples is merely an example of a particularly suitable application of the invention.

In some preferred embodiments of the invention, the apparatus further comprises a weighing device arranged to measure the total mass of the sample, whereby in use the average thickness of each of the differing substances in the sample over the predetermined area of each individual pixel is calculated by the data processing means using the X-ray radiation intensity data measured for that pixel and the measured total mass of the sample, and the average thickness of each substance is used by the data processing means to calculate the relative proportions by mass of the two or more differing substances contained in the sample. The weighing device preferably comprises an electronic weighing device, e.g. electronic scales, but substantially any scales or other types of weighing device may be used.

Preferably, the X-ray radiation generator is arranged to irradiate a sample with X-ray radiation at at least two differing X-ray radiation energies, whereby in use the average thickness of each of the differing substances in the sample over the predetermined area of each individual pixel is calculated by the data processing means using the X-ray radiation intensity data measured for that pixel for each of the differing X-ray radiation energies, and said average thickness is used by the data processing means to calculate the relative proportions by mass of the two or more differing substances contained in the sample.

To this end, the apparatus may comprise at least two X-ray radiation generators arranged to irradiate a sample with X-ray radiation at at least two differing X-ray radiation energies. More preferably, however, the apparatus comprises a single X-ray radiation generator which irradiates the sample with polychromatic X-ray radiation (i.e. X-ray radiation having a range of frequencies, i.e. a range of energies). Advantageously, the X-ray radiation, sensor(s) preferably detect(s) the polychromatic X-ray radiation at each of two differing radiation energies.

According to a second aspect, the invention provides a process of determining the relative proportions by mass of two or more differing substances contained in a sample comprising a combination (e.g. a mixture) of the two or more differing substances, by means of an apparatus according to the first aspect of the invention, the process comprising:
(a) positioning the sample between the X-ray radiation generator and the sensor;
(b) irradiating the sample by the generator;
(c) causing each pixel of the sensor to detect the intensity of X-ray radiation received by it, and measuring the X-ray radiation intensity detected by each pixel; and
(d) calculating, by the data processing means, the relative proportions by mass of the two or more differing substances contained in the sample, using the X-ray radiation intensity data measured by the sensor.

Preferably the process comprises the further step of measuring the total mass of a sample by means of a weighing device and calculating, by the data processing means, the average thickness of each of the differing substances in the sample over the predetermined area of each individual pixel using the X-ray radiation intensity data measured for that pixel and the measured total mass of the sample, and calculating the relative proportions by mass of the two or more differing substances contained in the sample by means of said average thickness.

Advantageously, the process may comprise the further step of irradiating a sample with X-ray radiation at at least two differing X-ray radiation energies and calculating, by the data processing means, the average thickness of each of the differing substances in the sample over the predetermined area of each individual pixel using the X-ray radiation intensity data measured for that pixel for each of the differing X-ray radiation energies, and calculating the relative proportions by mass of the two or more differing substances contained in the sample by means of said average thickness.

As mentioned above, preferably the sample comprises animal flesh, and the differing substances contained in the sample comprise, respectively, meat and fat.

Additional preferred features of the invention are described below, and in the dependent claims.

The invention will now be described, by way of example, with reference to the accompanying drawings, of which:

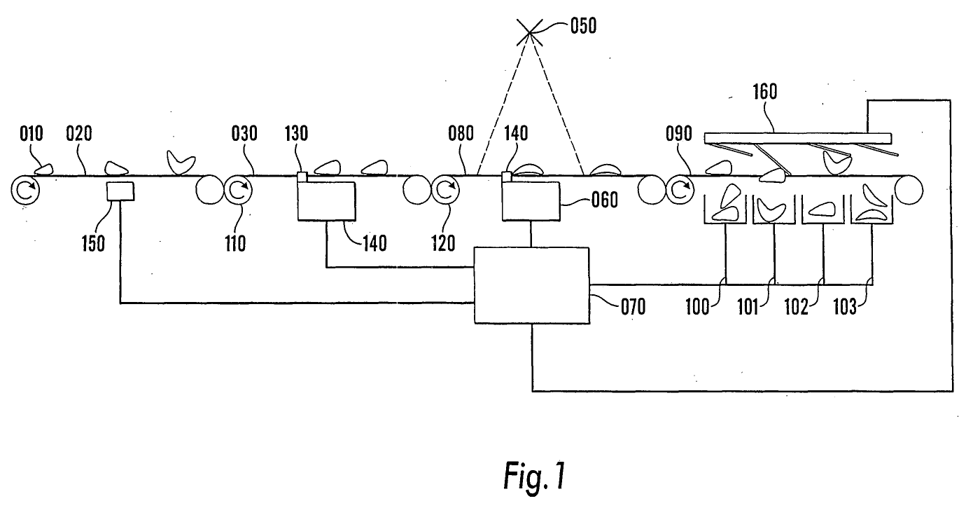

FIG. 1 shows, schematically, a preferred embodiment of the process and apparatus of the invention;

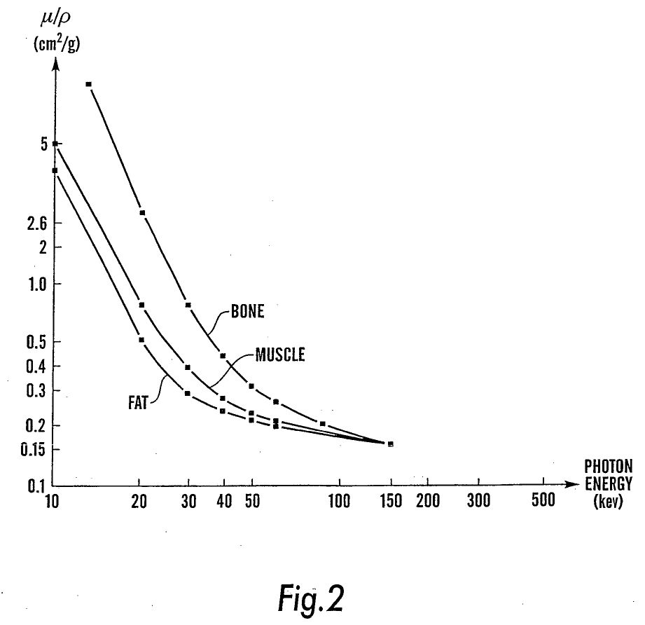

FIG. 2 is a graphical representation showing the attenuation of X-ray radiation respectively in bone, muscle (i.e. meat) and fat as a function of X-ray energy;

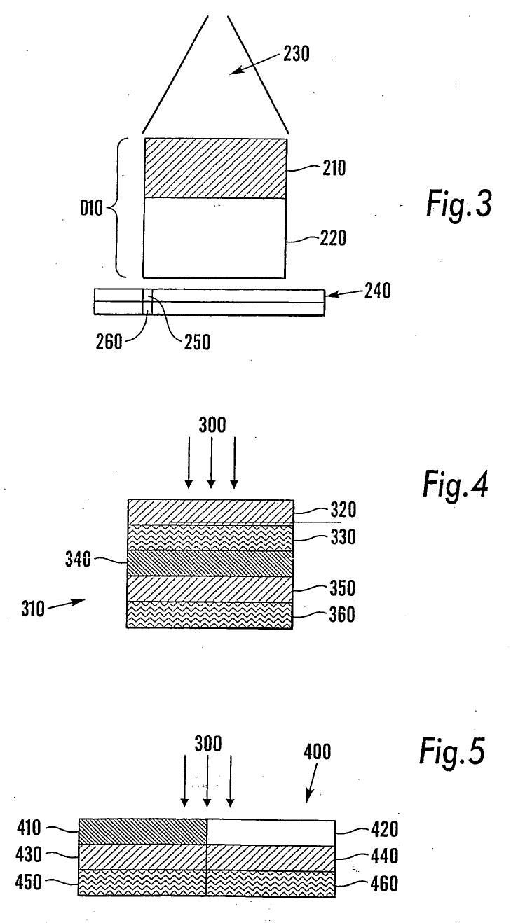

FIG. 3 is a schematic diagram showing the relationship between the X-ray radiation generated by the X-ray generator, a sample being analysed, and the sensor, according to the invention;

FIG. 4 is a schematic diagram showing components of a dual-energy X-ray sensor embodiment which may be used in the invention; and

FIG. 5 is a schematic diagram showing components of a further dual-energy X-ray sensor embodiment which may be used in the invention.

As shown in the schematic diagram of FIG. 1, individual samples 010 (i.e. pieces of meat containing fat) pass along a conveyor belt 020 and have their temperature measured by an infra-red sensor 150. The temperature data, which is sent to a central computer (i.e. a data processing means) 070, is used by the computer to compensate for any temperature variations, since the density of fat varies with temperature. The pieces of meat are then transferred onto another conveyor belt 030, which passes over an in-line weighing device 040. The in-line weighing device feeds the total weight of the piece of meat to the central computer 070. The piece of meat then passes onto another conveyor belt 080, which passes between an X-ray tube 050 (i.e. an X-ray radiation generator) and a real-time X-ray radiation sensor 060. The real-time X-ray sensor 060 produces an X-ray image of the piece of meat, which is then communicated to the computer 070. Thus for each piece of meat passing through the system the computer has a measurement of the total weight of the piece of meat and an X-ray image of the piece of meat. The system can also attach a code number to each piece to allow tracking of each individual item. The measurement of the weight of the piece of meat and the corresponding x-ray image can be synchronised by one of two methods.

The first method is to place a first tachometer 110 on the conveyor belt of the in-line weighing device and a second tachometer 120 on the conveyor belt of the real time X-ray sensing device. By knowing the speeds of the two conveyor belts the time for the meat to pass from the in-line weighing device to the X-ray sensing device is known. The computer can therefore store the measurement from the in-line weighing device for a fixed amount of time before combining this measurement with the X-ray image from the X-ray sensor.

A second method of tracking/linking the two measurements is to place a first photo-sensor 130 just before the weighing device and a second photo-sensor 140 just before the x-ray sensor. By counting the pieces of meat with the respective photo-sensors it is possible to link the two measurements.

An explanation of how the data processing means of the apparatus and process according to the invention may determine, for example, the relative proportions by mass of meat and fat in a sample combination of meat and fat is provided below. This explanation is provided merely by way of example, and the invention (at least in its broadest aspects) is not intended to be limited by any particular data processing method or calculation, or by any particular theory.

### EXAMPLE 1

### Single Energy X-Ray Radiation Calculation

It is known that the density of meat (i.e. muscle) is typically 1.07 to 1.08 g/cm³ whereas the density of fat is typically approximately 0.9 g/cm³. It is also known that the X-ray attenuation of fat, muscle and bone vary as a function of X-ray radiation energy as shown in FIG. 2. The y-axis of FIG. 2 shows X-ray attenuation or absorption in terms of μ/ρ (measured in cm²/g), where μ is the linear coefficient of X-ray absorption and ρ is the density of the sample (in units of g/cm³). The x-axis shows X-ray photon energy in kev.

By knowing: (i) the X-ray attenuation of meat and fat at the particular X-ray radiation energy or energies detected by the sensor; (ii) the mass of a sample comprising a combination of lean meat and fat; and (iii) having the sample's X-ray absorption image; the data processing means is able to determine, in accordance with the invention, the proportions by mass of fat and lean meat in the sample by means of the calculation below.

As illustrated schematically in FIG. 3, the sample 010 containing both meat 220 and fat 210 will pass (via the conveyor belt 080) through the X-ray beam 230 and hence will cause a change in the response of the X-ray sensor 240 due to the sample absorbing some of the X-ray energy. (The sensor 240 shown in FIG. 3 is in fact a dual-energy sensor as described in more detail below with respect to a dual-energy process in accordance with an alternative embodiment of the invention. In the dual-energy sensor, each pixel of the sensor has two portions, a first portion 250 for detecting a first X-ray energy and a second portion 260 for detecting a second X-ray energy. In the present Example only a single X-ray energy is measured, i.e. only one of the portions 250 or 260 is used. Alternatively a single-energy sensor may be used.) The sensor comprises an array of pixels arranged to generate an X-ray image of the sample.

The X-ray intensity that will be detected by the sensor can be calculated using the following equation.
I₁=I₀·exp(−μx) Eqn. 1.1
where I₁ is the received intensity of X-rays through the sample, μ is the initial intensity of the X-rays (or what is measured with no sample), li is the coefficient of X-ray absorption and x is the thickness of the sample the X-rays are penetrating through. In the case of the sample containing both meat and fat (for example), there is an absorption coefficient for each material and thickness. Hence, equation 1.1 can be re-written as follows:
I₁=I₀·exp(−μ_{fat}x_{fat}−μₘₑₐₜxₘₑₐₜ) Eqn. 1.2
In equation 1.2, I₁ and I₀ can be measured per pixel from the X-ray image, μ_{fat} and μₘₑₐₜ are known quantities from previous work in the field, and x_{fat} and Xₘₑₐₜ need to be determined to calculate the volume of each section that covers a pixel (the area of the pixel will already be known from the sensor dimensions). By using the simple relation of:
mass(m)=density(ρ)×volume(V) Eqn. 1.3
the relative mass of each section that covers the area of the pixel can then be determined by applying equation 1.3 to each section as follows:
m_{fat}=ρ_{fat}·Aₚᵢₓₑₗ·x_{fat} Eqn. 1.4
mₘₑₐₜ=ρₘₑₐₜ·Aₚᵢₓₑₗ·xₘₑₐₜ Eqn. 1.5
where Aₚᵢₓₑₗ is the area covered by one pixel of the sensor, a known value. The densities of each section will also be known values. In order to calculate the amount of mass of each section covered by the X-ray image, the next step is then to add together all the values produced by equations 1.4 and 1.5 for all the pixels in the image. This is done by integrating the equations over the area of the image.

$$\begin{matrix}{\int \int }_{xy} {m}_{fat} ⅆ x ⅆ y = {\int \int }_{xy} {ρ}_{fat} \cdot {A}_{pixel} \cdot {x}_{fat} ⅆ x ⅆ y & Eqn . 1.6 \\ {\int \int }_{xy} {m}_{meat} ⅆ x ⅆ y = {\int \int }_{xy} {ρ}_{meat} \cdot {A}_{pixel} {x}_{meat} ⅆ x ⅆ y & Eqn . 1.7\end{matrix}$$

Adding the final values of equations 1.6 and 1.7 together gives a value for the total mass of the sample, and hence the relative percentages of mass of fat and meat are given by the equations below:

$$\begin{matrix}\frac{{m}_{fat}}{{m}_{fat} + {m}_{meat}} \times 100 = \% fat & Eqn . 1.8 \\ \frac{{m}_{meat}}{{m}_{fat} + {m}_{meat}} \times 100 = \% meat & Eqn . 1.9\end{matrix}$$

However, just by using a single energy X-ray image by itself will not give rise to values of x_{fat} and xₘₑₐₜ. Another measurement is required. If the total mass of the sample is measured as well, then this information can be used to link equations 1.6 and 1.7 together as follows:

$$\begin{matrix}{m}_{meat + fat} = {\int \int }_{xy} {ρ}_{fat} \cdot {A}_{pixel} \cdot {x}_{fat} ⅆ x ⅆ y + \\ {\int \int }_{xy} {ρ}_{meat} \cdot {A}_{pixel} \cdot {x}_{meat} ⅆ x ⅆ y\end{matrix}$$

and as the two integral terms are integrated over the same limits (the image area), they can be combined to produce the following equation:

$${m}_{meat + fat} = {\int \int }_{xy} {A}_{pixel} ( {ρ}_{fat} \cdot {x}_{fat} + {ρ}_{meat} \cdot {x}_{meat} ) ⅆ x ⅆ y \qquad Eqn . 1.10$$

Combining equations 1.2 and 1.10, gives two equations and two unknown quantities, namely x_{fat} and xₘₑₐₜ. Next, equation 1.2 is re-arranged to obtain x_{fat} in terms of xₘₑₐₜ (or vice versa) as follows:—

$${x}_{fat} = \frac{- 1}{{μ}_{fat}} [ {ln ( \frac{{I}_{1}}{{I}_{0}} )}_{pixel} + {μ}_{meat} \cdot {x}_{meat} ] \qquad Eqn . 1.11$$

and then this value is substituted for x_{fat} in equation 1.10. This produces an equation in terms of xₘₑₐₜ only.

$${m}_{meat + fat} = {\int \int }_{xy} {A}_{pixel} [ \frac{- {ρ}_{fat}}{{μ}_{fat}} [ {ln ( \frac{{I}_{1}}{{I}_{0}} )}_{pixel} + {μ}_{meat} \cdot {x}_{meat} ] + {ρ}_{meat} \cdot {x}_{meat} ] ⅆ x ⅆ y$$

By replacing

$${\int \int }_{xy} {A}_{pixel} ⅆ x ⅆ y$$

with A_{image}, the equation can then be re-arranged as follows:

$$\frac{{m}_{meat + fat}}{{A}_{image}} = {\int \int }_{xy} \frac{- {ρ}_{fat}}{{μ}_{fat}} [ {ln ( \frac{{I}_{1}}{{I}_{0}} )}_{pixel} + {μ}_{meat} \cdot {x}_{meat} ] + {ρ}_{meat} \cdot {x}_{meat} ] ⅆ x ⅆ y$$

which can be re-arranged to produce:

$$\frac{{m}_{meat + fat}}{{A}_{image}} = {\int \int }_{xy} \frac{- {ρ}_{fat}}{{μ}_{fat}} {ln ( \frac{{I}_{1}}{{I}_{0}} )}_{pixel} + ( \frac{{ρ}_{meat} \cdot {μ}_{fat} - {ρ}_{fat} \cdot {μ}_{meat}}{{μ}_{fat}} ) {x}_{meat} ⅆ x ⅆ y$$

The next step is then to obtain xₘₑₐₜ as the subject of the equation as follows:

$${\int \int }_{xy} ( \frac{{ρ}_{meat} \cdot {μ}_{fat} - {ρ}_{fat} \cdot {μ}_{meat}}{{μ}_{fat}} ) {x}_{meat} ⅆ x ⅆ y = \frac{{m}_{meat + fat}}{{A}_{image}} + {\int \int }_{xy} \frac{- {ρ}_{fat}}{{μ}_{fat}} ln {( \frac{{I}_{1}}{{I}_{0}} )}_{pixel} ⅆ x ⅆ y$$

Each term is then multiplied by μ_{fat} (assuming, this is constant for the whole sample), and also ρₘₑₐₜ·μ_{fat}−ρ_{fat}·μₘₑₐₜ is replaced with ω to give:

$${\int \int }_{xy} {x}_{meat} ⅆ x ⅆ y = \frac{{m}_{meat + fat} \cdot {μ}_{fat}}{{A}_{image} \cdot ω} + {\int \int }_{xy} \frac{{ρ}_{fat}}{ω} {ln ( \frac{{I}_{1}}{{I}_{0}} )}_{pixel} ⅆ x ⅆ y \qquad Eqn . 1.12$$

hence for one pixel:

$${x}_{meat} = \frac{1}{ω} [ \frac{{m}_{meat + fat} \cdot {μ}_{fat}}{{A}_{image}} + {ρ}_{fat} {ln ( \frac{{I}_{1}}{{I}_{0}} )}_{pixel} ] \qquad Eqn . 1.13$$

and by using the value for xₘₑₐₜ, from equation 1.13, in equation 1.11 produces an expression for x_{fat} as follows:

$${x}_{fat} = \frac{- 1}{{μ}_{fat}} [ {ln ( \frac{{I}_{1}}{{I}_{0}} )}_{pixel} + \frac{{μ}_{meat}}{ω} [ ( \frac{{m}_{meat + fat}}{{A}_{image}} ) + {ρ}_{fat} \cdot {ln ( \frac{{I}_{1}}{{I}_{0}} )}_{pixel} ] ] \qquad Eqn . 1.14$$

Therefore, by using, equations 1.13 and 1.14, the thickness of the meat and the fat sections can be determined for each pixel in the image. Equations 1.4 and 1.5 can then be used to determine the mass of the meat and fat sections per pixel of the image and by adding all of these values together across the image (equations 1.6 and 1.7), the values of the mass of meat and fat in the image can then be calculated. All that then remains to do is to use equations 1.8 and 1.9 to produce the percentage of the mass of the sample in the image that is fat and the percentage that is meat.

Additionally or alternatively, the information required to calculate percentages of meat and fat in the sample can be based on data from X-ray images taken at two (or more) X-ray energy levels. i.e. The weighing device may be dispensed with by using two or more X-ray energy levels, or an even more accurate apparatus and process according to the invention may use a weighing device and two or more X-ray energy levels.

An example of how the data processing means may calculate the percentages of meat and fat in a sample based entirely on data from X-ray images taken at two differing X-ray radiation energies will now be described (i.e. in this example the weighing device is dispensed with).

### EXAMPLE 2

### Dual Energy X-ray Radiation Calculation

As can be seen from FIG. 2, the X-ray absorption coefficient of flesh and fat varies as a function of the voltage (kV) across the X-ray tube. Therefore, by taking two X-ray images, one at kV₁ and the other at kV₂ it is possible to measure a ratio of X-ray absorption and thus a ratio of meat/fat from the two images. By combining this ratio with information on the densities of meat and fat, together with the volume of the sample it is possible to measure the percentage by mass of fat and lean in the sample.

The sample containing both meat and fat will pass through the X-ray beam and hence will cause a change in the response of the X-ray sensor due to the sample absorbing some of the X-ray energy. The X-ray intensity that will be detected by the sensor can be calculated using the following equation.
I₁=I₀·exp(−μx) Eqn. 2.1
where I₁ is the received intensity of X-rays through the sample, I₀ is the initial intensity of X-rays (or what is measured with no sample), μ is the coefficient of X-ray absorption and x is the thickness of the sample the X-rays are penetrating through. In the case of the sample containing both meat and fat, there is an absorption coefficient for each material and thickness. Hence, equation 2.1 can be re-written as follows:
I₁−I₀·exp(−μ_{fat}x_{fat}−μₘₑₐₜxₘₑₐₜ) Eqn. 2.2
In equation 2.2, I₁ and I₀ can be measured per pixel from the X-ray image, μ_{fat} and μₘₑₐₜ are known quantities, and x_{fat} and xₘₑₐₜ need to be determined to calculate the volume of each section that covers a pixel, knowing the area of the pixel from the sensor. The X-ray absorption coefficient is related to the X-ray energy being used. In the case of the dual energy X-ray system, there are two such energies, one higher and one lower. By using the subscripts ‘HE’ for the higher energy and ‘LE’ for the lower energy, then equation 2.2 will produce two separate equations as follows:
I_{1 HE}=I_{0 HE}·exp(−μ_{fat}_{_{HE}}·x_{fat}−μₘₑₐₜ_{_{HE}}·xₘₑₐₜ) Eqn. 2.3
I_{1 LE}=I_{0 HE}·exp(−μ_{fat}_{_{LE}}·x_{fat}−μₘₑₐₜ_{_{LE}}·xₘₑₐₜ) Eqn. 2.4
In equations 2.3 and 2.4 there are two unknowns, namely x_{fat} and xₘₑₐₜ and hence by solving these two equations simultaneously, values for these two thicknesses can be obtained. The first step is to re-arrange equation 2.3 to obtain x_{fat} in terms of xₘₑₐₜ (this could equally be done by using equation 2.4 or obtaining xₘₑₐₜ in terms of x_{fat}), and the second step is to substitute this expression into equation 2.4:

$$\text{Step 1:}$$

$${x}_{fat} = \frac{- 1}{{μ}_{{fat}_{HE}}} [ ln ( \frac{{I}_{1 HE}}{{I}_{0 HE}} ) + {μ}_{{meat}_{HE}} \cdot {x}_{meat} ] \\ \text{Step 2:} \\ {I}_{1 LE} = {I}_{0 LE} \cdot exp [ \frac{{μ}_{{fat}_{LE}}}{{μ}_{{fat}_{HE}}} ( ln ( \frac{{I}_{1 HE}}{{I}_{0 HE}} ) + {μ}_{{meat}_{HE}} \cdot {x}_{meat} ) - {μ}_{{meat}_{LE}} \cdot {x}_{meat} ] \qquad Eqn . 2.5$$

Which can be re-arranged as follows:

$$ln ( \frac{{I}_{1 LE}}{{I}_{0 LE}} ) = [ \frac{{μ}_{{fat}_{LE}}}{{μ}_{{fat}_{HE}}} ( ln ( \frac{{I}_{1 HE}}{{I}_{0 HE}} ) + {μ}_{meat HE} \cdot {x}_{meat} ) ] - {μ}_{meat LE} \cdot {x}_{meat}$$

and then begin to move xₘₑₐₜ to be the subject of the equation:

$${x}_{meat} [ \frac{{μ}_{{fat}_{LE}} \cdot {μ}_{meat HE} - {μ}_{meat LE} \cdot {μ}_{{fat}_{HE}}}{{μ}_{{fat}_{HE}}} ] = \frac{- {μ}_{{fat}_{LE}}}{{μ}_{{fat}_{HE}}} \cdot ln ( \frac{{I}_{{1}_{HE}}}{{I}_{0 HE}} ) + ln ( \frac{{I}_{1 LE}}{{I}_{0 LE}} )$$

and by replacing the term μ_{fat}_{_{LE}}·μₘₑₐₜ_{_{HE}}−μₘₑₐₜ_{_{LE}}·μ_{fat}_{_{He}} with the symbol D an equation for xₘₑₐₜ in terms of known/measured values is as follows:

$${x}_{meat} = \frac{1}{Φ} [ {μ}_{{fat}_{HE}} \cdot ln ( \frac{{I}_{1 LE}}{{I}_{0 LE}} ) - {μ}_{{fat}_{LE}} \cdot ln ( \frac{{I}_{1 HE}}{{I}_{0 HE}} ) ] \qquad Eqn . 2.6$$

and by substituting the expression for xₘₑₐₜ from equation 2.6 into equation 2.5, an expression for x_{fat} in terms of known/measured quantities can also be obtained.

$${x}_{fat} = \frac{- 1}{{μ}_{{fat}_{HE}}} [ ln ( \frac{{I}_{1 HE}}{{I}_{0 HE}} ) + {μ}_{meat HE} \cdot \frac{1}{Φ} [ {μ}_{{fat}_{HE}} \cdot ln ( \frac{{I}_{1 LE}}{{I}_{0 LE}} ) - {μ}_{{fat}_{LE}} \cdot ln ( \frac{{I}_{1 HE}}{{I}_{0 HE}} ) ] ]$$

which when re-arranged produces:

$${x}_{fat} = [ \frac{- 1}{{μ}_{{fat}_{HE}}} + \frac{{μ}_{meat HE} \cdot {μ}_{{fat}_{LE}}}{Φ \cdot {μ}_{{fat}_{HE}}} ] \cdot ln ( \frac{{I}_{1 HE}}{{I}_{0 HE}} ) - [ \frac{{μ}_{meat HE}}{Φ} ] \cdot ln ( \frac{{I}_{1 LE}}{{I}_{0 LE}} ) \qquad Eqn . 2.7$$

re-arranging the factor multiplying the logarithmic intensity ratio at high energy:

$${x}_{fat} = \frac{1}{Φ} [ ( \frac{{μ}_{meat HE} \cdot {μ}_{{fat}_{LE}} - Φ}{{μ}_{{fat}_{HE}}} ) \cdot ln ( \frac{{I}_{1 HE}}{{I}_{0 HE}} ) - {μ}_{meat HE} \cdot ln ( \frac{{I}_{1 LE}}{{I}_{0 LE}} ) ]$$

by expanding the Φ term, the factor can be simplified:

$${x}_{fat} = \frac{1}{Φ} [ ( \frac{{μ}_{meat HE} \cdot {μ}_{{fat}_{LE}} - {μ}_{{fat}_{LE}} \cdot {μ}_{meat HE} + {μ}_{meat LE} \cdot {μ}_{{fat}_{HE}}}{{μ}_{{fat}_{HE}}} ) \cdot ln ( \frac{{I}_{1 HE}}{{I}_{0 HE}} ) - {μ}_{meat HE} \cdot ln ( \frac{{I}_{1 LE}}{{I}_{0 LE}} ) ]$$

$${x}_{fat} = \frac{1}{Φ} [ {μ}_{meat LE} \cdot ln ( \frac{{I}_{1 HE}}{{I}_{0 HE}} ) - {μ}_{meat HE} \cdot ln ( \frac{{I}_{1 LE}}{{I}_{0 LE}} ) ] \qquad Eqn . 2.8$$

By using the simple relation of:
mass(m) density(ρ)×volume(V)
the mass of the fat and the meat sections can be derived as follows:
massₘₑₐₜ=ρₘₑₐₜ×Vₘₑₐₜ(=ρ_{fat}×Areaₚᵢₓₑₗ×xₘₑₐₜ) Eqn. 2.9
mass_{fat}=ρ_{fat}×V_{fat}(=ρ_{fat}×Areaₚᵢₓₑₗ×x_{fat}) Eqn. 2.10
and then all of the values derived from equations 2.9 and 2.10 for all of the pixels in the X-ray image are added together. Once the total values for the mass of the meat and the fat have been calculated, the relative percentage of the mass of each (i.e. meat and fat) is simply a ratio of the relevant mass and the total mass of the sample.

Methods for the generation of dual-energy x-ray images are known in the art, for example with respect to bone mineral density analysis for the early detection of osteoporosis. One technique is to use two different X-ray tubes operating at different energies each with their own sensor optimised for each tube. In the present invention, there may be two X-ray tubes separated along the conveyor belt, and since the speed of the conveyor belt is known a simple delay in electronic image acquisition will register the two images. However, this technique is presently not preferred for this invention.

A second technique known in the technical literature is to pulse the X-ray tube at two different energies. This works well with a linear X-ray sensor, where one line of data is acquired at one X-ray energy, the next line of data at the second energy, and so on. However, this technique too is not preferred for the present invention.

A third technique used, for example, in baggage security applications, is to place two rows of X-ray sensitive elements on top of each other, as shown schematically in FIG. 4. The sensor 310 comprises an upper scintillator layer 320 and an associated upper photodiode layer 330, a filter 340 then separates the upper layers from a lower scintillator layer 350 and an associated lower photodiode layer 360. The X-ray beam 300 is polychromatic and hence the upper photodiode 330 is more responsive towards the lower energy X-ray photons and the lower photodiode 360 is more responsive towards the higher energy X-ray photons. Such a scheme offers two advantages; the first is the fact that the wire bonding leads can leave the photodiode array on both sides thus making semiconductor fabrication easier. The second advantage is that registration of the two images is immediate. A disadvantage of such a scheme is that it suffers from signal noise. The cause of this noise is that high-energy X-ray photons pass through the structure of the upper photodiode 330 on their way to the lower photodiode 360.

The presently preferred X-ray sensor embodiment according to the present invention is a dual-energy X-ray sensor 400 comprising two strips of photodiode, each with their own optimised filter/scintillating material, as shown schematically in FIG. 5. Each pixel of sensor 400 comprises side-by-side strips, each of which comprises a filter 410 or 420, below this a scintillator 430 or 440, and below this a photodiode 450 or 460. Each strip (comprising its respective filter, scintillator and photodiode) is arranged to detect X-rays of a particular energy—i.e. one of the two energies detected. Such a structure enables optimum selection of the filter material and thickness, and scintillator material & thickness for the different parts of the X-ray spectrum. Although this dual-energy sensor is presently the most preferred, it is possible to use other dual-energy x-ray imaging systems (for example those described above) in the apparatus and process of the present invention.

According to a third aspect, the present invention provides a process of dividing a plurality of samples, each of which comprises a combination of two or more differing substances, into two or more groups of the samples, the process comprising:
(i) determining the masses of each differing substance in each individual sample; and
(ii) placing each sample into a respective group of the samples according to the masses of each differing substance in that sample such that each group has an overall mass ratio of the two or more differing substances which at least approximates to a predetermined target mass ratio for that group.

Preferably the masses of each differing substance in each individual sample according to the third aspect of the invention are determined by means of an apparatus according to the first aspect of the invention or a process according to the second aspect of the invention.

Preferably, the groups of samples are formed gradually by determining sequentially which group a particular sample (or a particular plurality of samples, as the case may be) is to be placed in, according to the masses of the differing substances in that sample (or plurality of samples) and according to the existing overall mass ratio of the differing substances in each group (if any—i.e. if there are any samples already placed in groups), such that the new overall mass ratio in each group after such placement at least approximates to the predetermined target mass ratio for that group.

It is particularly preferred for each sample to be placed in its respective group substantially immediately subsequent to the masses of the differing substances in that sample having been determined.

Preferably the samples according to the third aspect of the invention comprise animal flesh, and the differing substances contained in the sample comprise, respectively, meat and fat, but the process is applicable generally.

The right hand side of FIG. 1 (as drawn) illustrates, schematically, an example of the process according to the third aspect of the invention (which, as already mentioned, is a preferred feature of the first and second aspects of the invention). This process will now be described, by way of example, with reference to FIG. 1.

Once each sample piece of meat (containing lean meat and fat) has had its proportions of meat and fat determined, the output of the computer 070 will be a result x grams meat +/−error and y grams fat +/−error. The goal of the meat producer is to have a collection of meat with a target fat % so that they can make their final product as close to the target fat % as possible.

After the X-ray system (conveyor belt 080) is another conveyor belt 090, which includes a series of mechanisms 160 for displacing the graded samples into a series of grading bins 100-103 (four are shown in the current embodiment although any number is possible). The aim of the system is to end up with as close to the target fat/lean ratio as possible in each of the bins. Each of the first four pieces of meat entering the system is put into a bin. The fifth piece will then be deflected to one of the bins such that it moves the running (i.e. existing or cumulative) fat/lean ratio of that bin towards its predetermined target fat/lean ratio.

For example, if bin 100 had a fat/lean ratio greater than the target fat/lean ratio and bin 103 had a fat/lean ratio less than the target fat/lean ratio, then if the next sample measured proved to have more meat than fat, it would be manoeuvred to bin 100. Similarly, if the next sample measured had more fat, it would be manoeuvred to bin 103. In this way, over time, many samples will be sent towards each bin such that the bins will each contain the predetermined target fat/lean ratio overall. In addition, as long as the weighing/X-ray sensing system does not have any systematic errors then the cumulative error in each bin containing many sample pieces of meat will generally be much less than the error on any individual piece of meat.

1. An apparatus for determining the relative proportions by mass of two or more differing substances contained in a sample comprising a combination of the two or more differing substances, the apparatus comprising:
(a) at least one X-ray radiation generator arranged to irradiate said sample;
(b) at least one X-ray radiation sensor comprising a plurality of pixels, each pixel having a predetermined area and being arranged to detect the intensity of X-ray radiation received by it, the sensor being arranged to receive X-ray radiation from the generator and to measure the X-ray radiation intensity detected by each pixel; and
(c) data processing means;
wherein, in use, said sample is positioned between the X-ray radiation generator and the sensor and is irradiated by the generator, each pixel of the sensor detects the intensity of X-ray radiation received by it, the sensor measures the X-ray radiation intensity detected by each pixel, and the data processing means calculates the relative proportions by mass of the two or more differing substances contained in said sample, using X-ray radiation intensity data measured by the sensor.

2. The apparatus according to claim 1, further comprising a weighing device arranged to measure the total mass of said sample, wherein in use the average thickness of each of the differing substances in said sample over the predetermined area of each individual pixel is calculated by the data processing means using the X-ray radiation intensity data measured for that pixel and the measured total mass of the sample, and said average thickness is used by the data processing means to calculate, the relative proportions by mass of the two or more differing substances contained in the sample.

3. The apparatus according to claim 1, wherein the X-ray radiation generator is arranged to irradiate said sample with X-ray radiation at at least two differing X-ray radiation energies, wherein in use the average thickness of each of the differing substances in a said sample over the predetermined area of each individual pixel is calculated by the data processing means using the X-ray radiation intensity data measured for that pixel for each of the differing X-ray radiation energies, and said average thickness is used by the data processing means to calculate the relative proportions by mass of the two or more differing substances contained in the sample.

4. The apparatus according to claim 1, comprising at least two X-ray radiation generators, each of which is arranged to irradiate said sample with X-ray radiation at an X-ray radiation energy which differs from that with which the other generator is arranged to irradiate the sample, wherein in use the average thickness of each of the differing substances in said sample over the predetermined area of each individual pixel is calculated by the data processing means using the X-ray radiation intensity data measured for that pixel for each of the differing X-ray radiation energies, and said average thickness is used by the data processing means to calculate the relative proportions by mass of the two or more differing substances contained in the sample.

5. A method of determining the relative proportions by mass of two or more differing substances contained in a sample comprising a combination of the two or more differing substances, the method comprising:
(a) positioning said sample between an X-ray radiation generator and a sensor;
b) irradiating the sample with the generator;
(c) causing each pixel of the sensor to detect the intensity of X-ray radiation received by it, and measuring the X-ray radiation intensity detected by each pixel; and
(d) calculating with a data processor the relative proportions by mass of the two or more differing substances contained in said sample, using the X-ray radiation intensity data measured by the sensor.

6. The method according to claim 5, comprising the further step of measuring the total mass of said sample with a weighing device, calculating with the data processor the average thickness of each of the differing substances in said sample over the predetermined area of each individual pixel using the X-ray radiation intensity data measured for that pixel and the measured total mass of the sample, and calculating the relative proportions by mass of the two or more differing substances contained in the sample by said average thickness.

7. The method according to claim 5, comprising the further step of irradiating said sample with X-ray radiation at at least two differing X-ray radiation energies, calculating, with the data processor the average thickness of each of the differing substances in said sample over the predetermined area of each individual pixel using the X-ray radiation intensity data measured for that pixel for each of the differing X-ray radiation energies, and calculating the relative proportions by mass of the two or more differing substances contained in the sample by average thickness.

8. The method according to claim 5, wherein the data processor calculates the actual masses of the two or more differing substances contained in said sample.

9. The method according to claim 5, further comprising measuring a temperature of said sample, and wherein the measured temperature data are used by the data processor to compensate for any difference in the temperature of said sample compared to another sample which affects the measured X-ray radiation intensity data due to the variation in the density of said sample with temperature.

10. A method of dividing a plurality of samples, each of which includes a combination of two or more differing substances, into two or more groups of the samples, the method comprising:
(i) determining the masses of each differing substance in each sample; and
(ii) placing each sample into a respective group of samples according to the masses of each differing substance in that sample such that each group has an overall mass ratio of the two or more differing substances which at least approximates to a predetermined target mass ratio for that group.

11. The method according to claim 10, further comprising determining the masses of each differing substance in each individual sample with an apparatus according to claim 1.

12. The method according to claim 10, further comprising forming the groups of samples gradually by determining sequentially which group a particular sample is to be placed according to the masses of the differing substances in that sample and according to an existing overall mass ratio of the differing substances in each group, such that a new overall mass ratio in each group after such placement at least approximates a predetermined target mass ratio for that group.

13. A method according to claim 12, further comprising placing each sample in its respective group substantially immediately subsequent to the masses of the differing substances in that sample having been determined.

14. The method according to claim 10, wherein the sample comprises animal flesh, and the differing substances contained in the sample comprise, respectively, meat and fat.

15. The method according to claim 14, wherein the sample is one of: raw, at least partly frozen, irregular in shape, irregular in size, irregular in mass, and contained in one or more open or closed container.

16. The method according to claim 10, wherein the determination of the proportions by mass of the two or more differing substances contained in said sample is used to determine subsequent processing of the sample.

17. The method according to claim 10, wherein the division of said plurality of samples into two or more said groups is used to determine subsequent processing of the groups of samples.

18. The method according to claim 17, wherein the subsequent processing comprises the addition of one or more additives to the samples.

19. The method according to claim 17, wherein the subsequent processing comprises one of the removal of a defective sample and the removal of defects from the sample.

20. The method according to claim 19, wherein said defect comprises bone.

21. The apparatus according to claim 1, wherein the data processing means calculates the actual masses of the two or more differing substances contained in said sample.

22. The apparatus according to claim 1, further comprising a temperatures sensor for measuring the temperature of said sample, wherein the data processing means employs the temperature to compensate for any changes in temperature between samples which affects the measured X-ray radiation intensity data.
